(19) United States
(12) Patent Application Publication
(10) Pub. No.: US 2019/0276243 A1
(43) Pub. Date: Sep. 12, 2019

(54) CHAIN CONVEYORS HAVING REMOVABLE LINERS AND DRIP PANS

(71) Applicant: Cannon Equipment LLC, Cannon Falls, MN (US)

(72) Inventor: Douglas Levine, Inver Grove Heights, MN (US)

(73) Assignee: Cannon Equipment LLC, Cannon Falls, MN (US)

(21) Appl. No.: 16/048,951

(22) Filed: Jul. 30, 2018

Related U.S. Application Data
(60) Provisional application No. 62/641,810, filed on Mar. 12, 2018.

(51) Int. Cl. B65G 45/26; B65G 21/00

(52) U.S. Cl. CPC B65G 45/26; B65G 2207/26; B65G 21/00

(57) ABSTRACT

A conveyor for conveying and supporting a chain includes a frame member having a first slot and a second slot spaced apart from each other along the frame member and a liner configured to support the chain relative to the frame member. A first fastener and a second fastener are spaced apart from each other and extend from the liner toward the frame member such that the liner is installed onto the frame member by moving the first fastener into the first slot and sliding the liner along the frame member until the second fastener is aligned with the second slot and can be moved into the second slot.

### CROSS-REFERENCE TO RELATED APPLICATION

The present application is based on and claims priority to U.S. Provisional Patent Application Ser. No. 62/641,810 filed Mar. 12, 2018, the disclosure of which is incorporated herein by reference.

### FIELD

The present disclosure relates to chain conveyors, and specifically continuous chain conveyors with removable liners and drip pans.

### BACKGROUND

Conventional chain conveyors, such as continuous chain conveyors, are used to convey products to and from different work stations within a factory along a path. The path includes multiple section (conveyor sections) connected to each other end-to-end. For instance, the path may include multiple straight conveyor sections and multiple curved conveyor sections that are connected to each other end-to-end. One or more chains, such as continuous chains, are conveyed along the conveyor sections. The chains are driven along the conveyor sections by one or more motors, and in the case of continuous chain conveyors the continuous chains are driven in continuous loops. Products, such as boxes, gallons of milk, and dairy cases, ride along the top of the chains and are transported along the path through the factory.

The following U.S. patent application Publication and U.S. patents are incorporated herein by reference in entirety.

U.S. Patent Application Publication No. 2018/0105365 discloses continuous chain conveyors that comprise a primary continuous chain having a first portion configured to carry objects along a path and a return portion. A motor is operably coupled to the primary continuous chain so as to induce movement of the chain, and a first sprocket engages the return portion of the primary continuous chain. Movement of the return portion causes the first sprocket to rotate. A second sprocket is coupled to the first sprocket by a drive shaft such that rotation of the first sprocket causes the second sprocket to rotate. An auxiliary chain is operably coupled to the second sprocket such that rotation of the second sprocket causes movement of the auxiliary chain.

U.S. Pat. No. 5,381,888 discloses a ratchet driven continuous chain accumulator conveyor and an accumulating and retrieval system that includes a frame having a pair of continuous chains. The chains are mounted on sprockets on either end of the accumulating conveyors and run in upper and lower chain channels. A hydraulic drive cylinder is supported by the frame of each accumulating conveyor and includes gravity dogs on an operable piston end thereof. The gravity dogs are for imparting a ratcheting motion to each pair of chains through extension and retraction of the drive cylinder. Each accumulating conveyor includes a plurality of lift means along the length thereof for lifting cases from contact with the driving chains for relieving weight pressure thereon. The accumulating and retrieval includes a computer control and loading mechanisms for automatically loading the accumulator conveyors with product.

U.S. Pat. No. 9,873,172 discloses an automated pallet checker system for checking the structural integrity of a pallet. The system includes a conveyor arrangement mounted on a framework and operable to convey the pallet to be checked through an in-feed station and a lift station connected to the in-feed station.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a conveyor for supporting a chain includes a frame member having a first slot and a second slot spaced apart from each other along the frame member and a liner configured to support the chain relative to the frame member. A first fastener and a second fastener are spaced apart from each other and extend from the liner toward the frame member such that the liner is installed onto the frame member by moving the first fastener into the first slot and axially sliding the liner along the frame member until the second fastener is aligned with the second slot and can be moved into the second slot.

In certain examples, a method for assembling a conveyor for supporting a chain includes the steps of positioning a first slot and a second slot along a frame member such that the first slot is spaced apart from the second slot and positioning a first fastener and a second fastener along a liner such that the first fastener and the second fastener extend from the liner toward the frame member. The liner is installed onto the frame member by moving the first fastener into the first slot and axially sliding the liner along the frame member until the second fastener is aligned with the second slot and can be moved into the second slot.

Various other features, objects, and advantages will be made apparent from the following description taken together with the drawings.

### BRIEF DESCRIPTION OF THE DRAWINGS

The present disclosure is provided with reference to the following Figures. The same numbers are used throughout the Figures to reference like features and like components.

FIG. 1 is a top-down plan view of a chain conveyor according to the present disclosure.

FIG. 2 is a perspective view of the chain conveyor of FIG. 1 within line 2-2 on FIG. 1 showing several conveyor sections of the present disclosure.

FIG. 3 is an enlarged view of the conveyor section of FIG. 2 within line 3-3 on FIG. 2. The conveyor section depicted has a motor and sprockets that drive continuous chains through the chain conveyor of the present disclosure. Continuous chains are excluded from one side of the conveyor section to show components of the conveyor section more clearly.

FIG. 4 is a perspective view of another conveyor section according to the present disclosure. The conveyor section depicted is a straight conveyor section.

FIG. 5 is an exploded view of the conveyor section shown in FIG. 4.

FIG. 6 is a perspective view of an end of the conveyor section shown in FIG. 4.

FIG. 7 is perspective view of another end of the conveyor section shown in FIG. 4.

FIG. 8 is a cross sectional view the conveyor section shown in FIG. 4 at a connection between a slot of a frame member and a fastener.

FIG. 9 is a top-down plan view of the conveyor section shown in FIG. 4. The conveyor section includes a liner installed onto a frame member and another frame member without a liner.

FIG. 10 is a cross sectional view of the conveyor section shown in FIG. 4 along the length of the liner. The liner is shown separated from the frame member.

FIG. 11 is a view like FIG. 10 with the liner installed onto the frame member.

FIGS. 12-14 are cross sectional views along the length of an example conveyor section similar to FIG. 4. FIGS. 12-14 depict an example liner removal sequence for removing the liner from the frame member.

FIG. 15 is a top perspective view of two conveyor sections adjacent to each other.

FIG. 16 is a perspective view of another example conveyor section of the present disclosure. The conveyor section depicted is a curved conveyor section.

FIG. 17 is a perspective view of an end of the conveyor section shown in FIG. 16.

FIG. 18 is an exploded view of the conveyor section shown in FIG. 16.

### DETAILED DESCRIPTION

Continuous chain conveyors are used in food processing facilitates and must be cleaned and washed regularly to maintain food and health standards and prolong operational life. Typically, conventional continuous chain conveyors must be disassembled for cleaning which requires that the entire continuous chain conveyor and other related machines be shut down for extended periods of time while cleaning occurs. Thus, the present inventor has endeavored to develop improved continuous chain conveyors and liners that can be easily cleaned by non-technical personnel with minimal shut down of the continuous chain conveyors and other machines. The present inventor has also endeavored to minimize the number of components, parts, and connections of each conveyor section. The present disclosure is a result of these efforts.

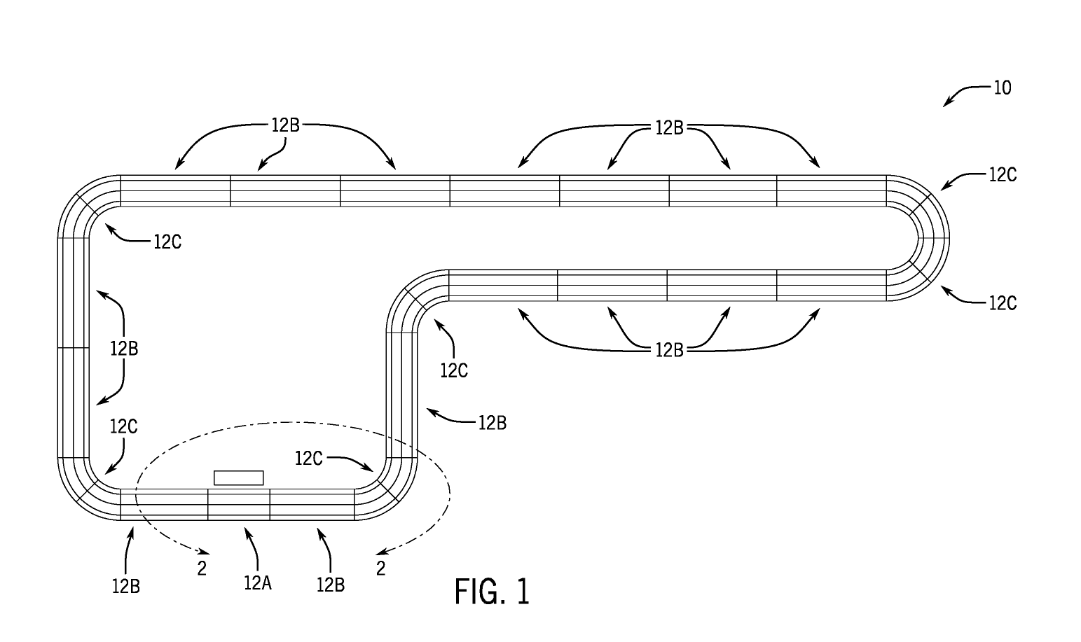

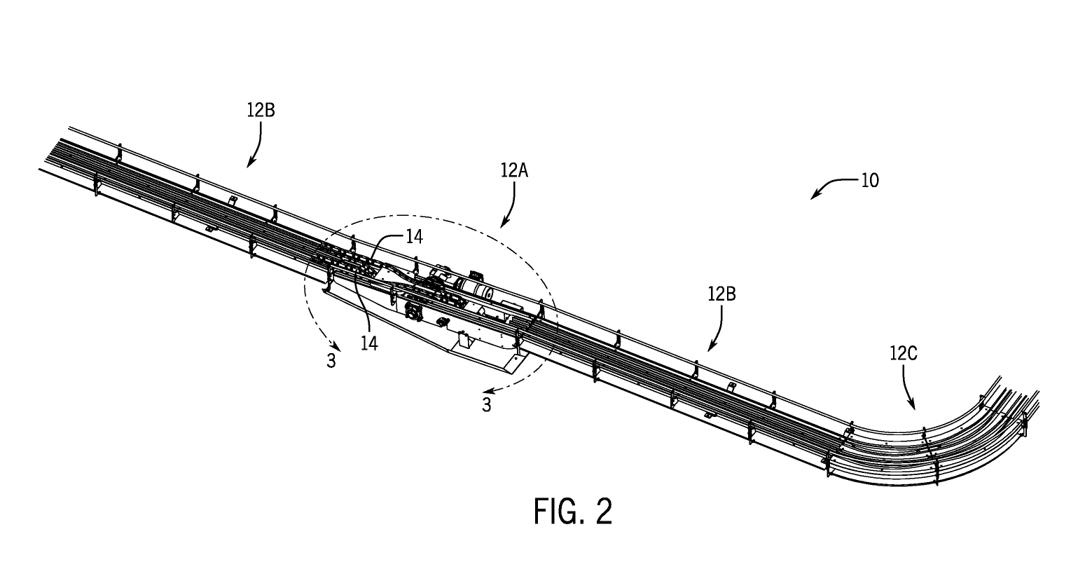

FIG. 1 is a top-down plan view of a chain conveyor 10 according to the present disclosure. The chain conveyor 10 includes conveyor sections 12A, 12B, 12C that are connected to each other end-to-end to form a path along which at least one chain 14 (see FIG. 2) is conveyed. The chain conveyor 10 can be used to convey products (not shown), such as dairy cases, which ride on top of the chains 14 to various stations, such as a cleaning station or a filling station, in a factory.

FIG. 2 is a perspective view of the conveyor sections 12A, 12B, 12C of the chain conveyor 10 shown in FIG. 1. The chain 14 is only partially shown so as to expose components of the conveyor sections 12A, 12B, 12C further discussed herein below. The chains 14 can be continuous chains, however a person or ordinary skill in the art will recognize that multiple continuous chains and/or different types of chains may be used. Details of the various conveyor sections 12A, 12B, 12C are described herein below, and a person having ordinary skill in the art will recognize that the details, descriptions, and components described with references to a specific conveyor section 12A, 12B, 12C may be applied to any of the conveyor sections 12A, 12B, 12C disclosed herein.

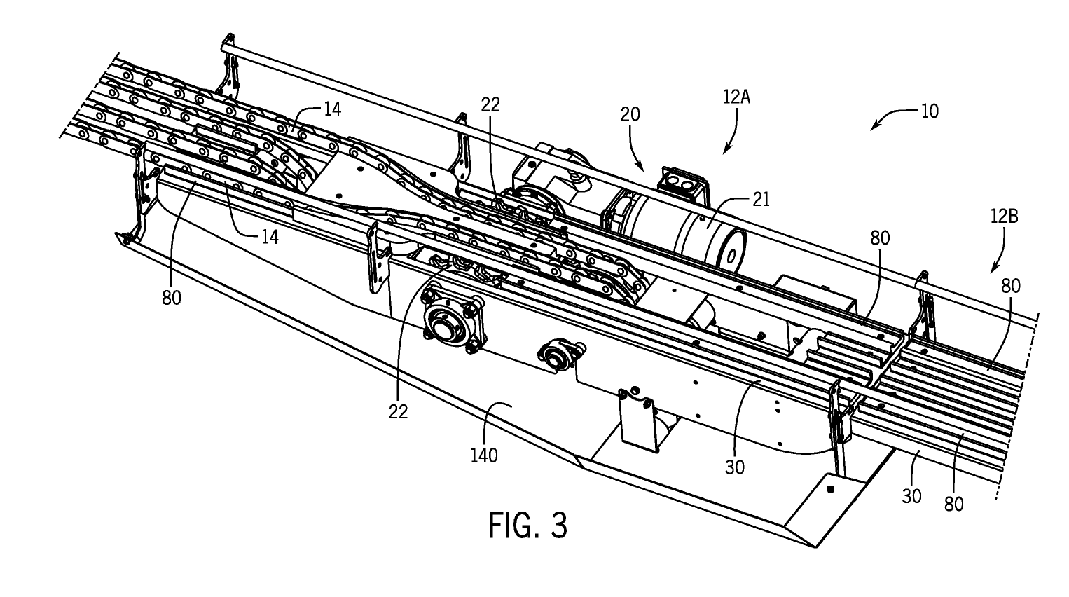

FIG. 3 depicts conveyor section 12A and a chain drive system 20 which drives the chains 14 along the conveyor section 12A and other adjacent conveyor sections, such as conveyor section 12B. The chain drive system 20 includes a motor 21 and sprockets 22 which engage and drive the chains 14. Reference is made to U.S. Patent Application Publication No. 2018/0105365, which is herein incorporated, for further description of an example chain and components thereof. For clarity the chains 14 in FIG. 3 are partially shown so as to expose components of the conveyor section 12A.

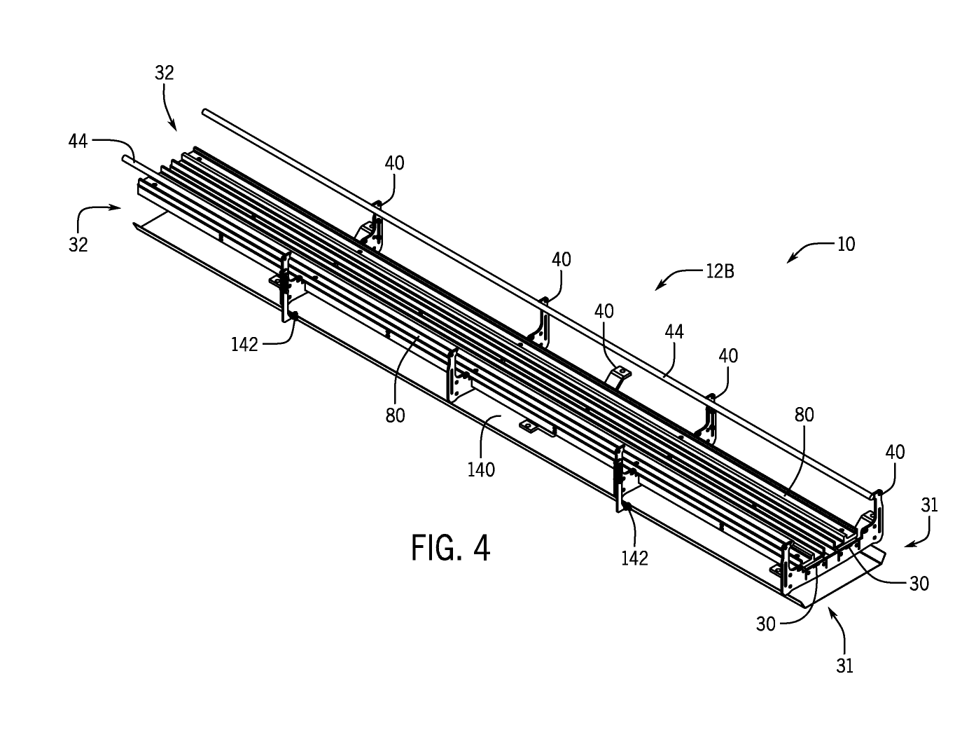

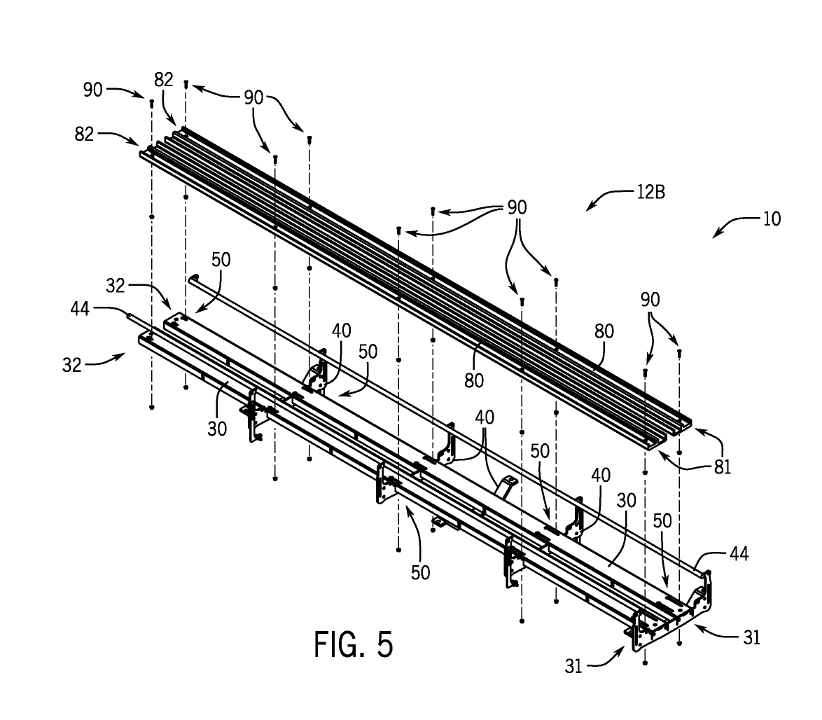

FIGS. 4-9 depict another example conveyor section 12B of the present disclosure. The conveyor section 12B depicted is a linear or straight conveyor section. The conveyor section 12B includes a pair of frame members 30 that extend between opposite frame ends, namely a first frame end 31 and a second frame end 32 (see FIG. 5). Each frame member 30 has an overall length, namely a frame length 36 (see FIG. 11), defined between the frame ends 31, 32. Each frame member 30 has a frame axis 33 (FIG. 6) along which the frame member 30 extends. The size and shape of the frame members 30 can vary (e.g. rods, plates), and in the example depicted the frame members 30 are C-shaped members.

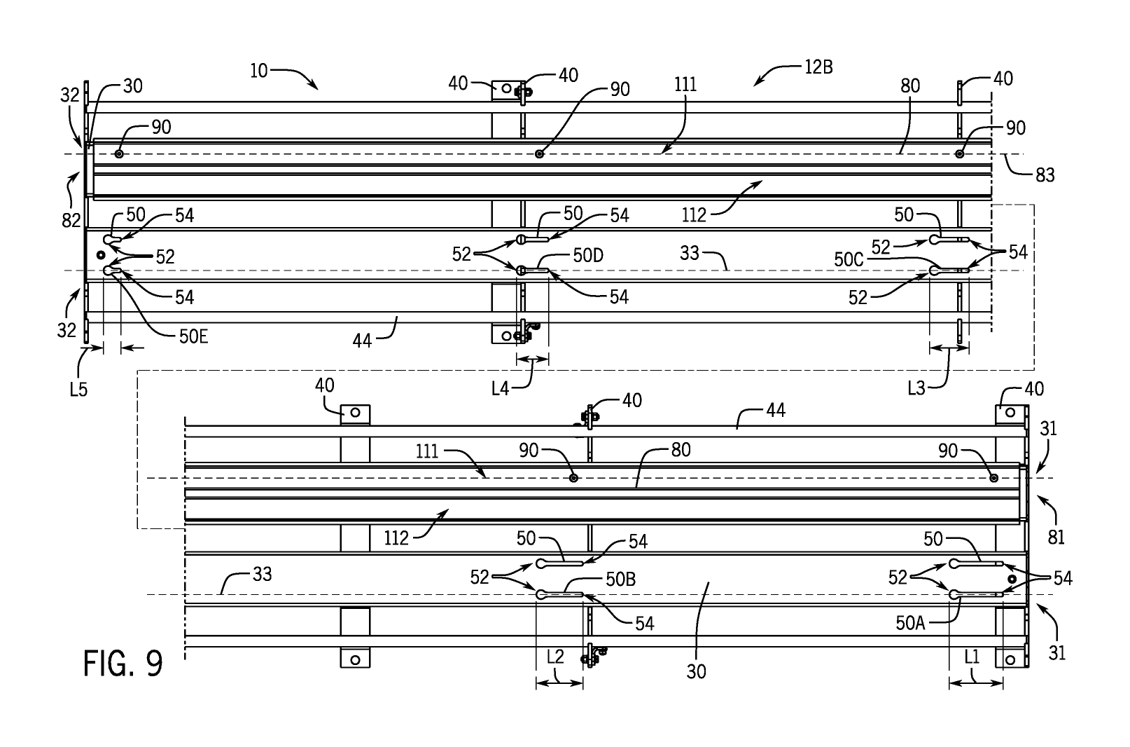

As is best seen in FIG. 9, the frame members 30 include multiple slots 50 that are spaced apart from each other along the frame members 30. In FIG. 9, one of the frame members 30 has a liner 80 installed thereon and the other frame member 30 does not have a liner 80 thereby exposing the slots 50. One or more slots 50 receive a fastener 90 (described herein) as the liner 80 is installed onto the frame member 30. The number and spacing of the slots 50 can vary. In FIG. 9, the slots 50 are shown in pairs and each pair of slots 50 are spaced apart from each other along the frame member 30. One slot 50 in each pair of slots 50 is aligned along the frame axis 33 of the frame member 30 (see FIG. 9).

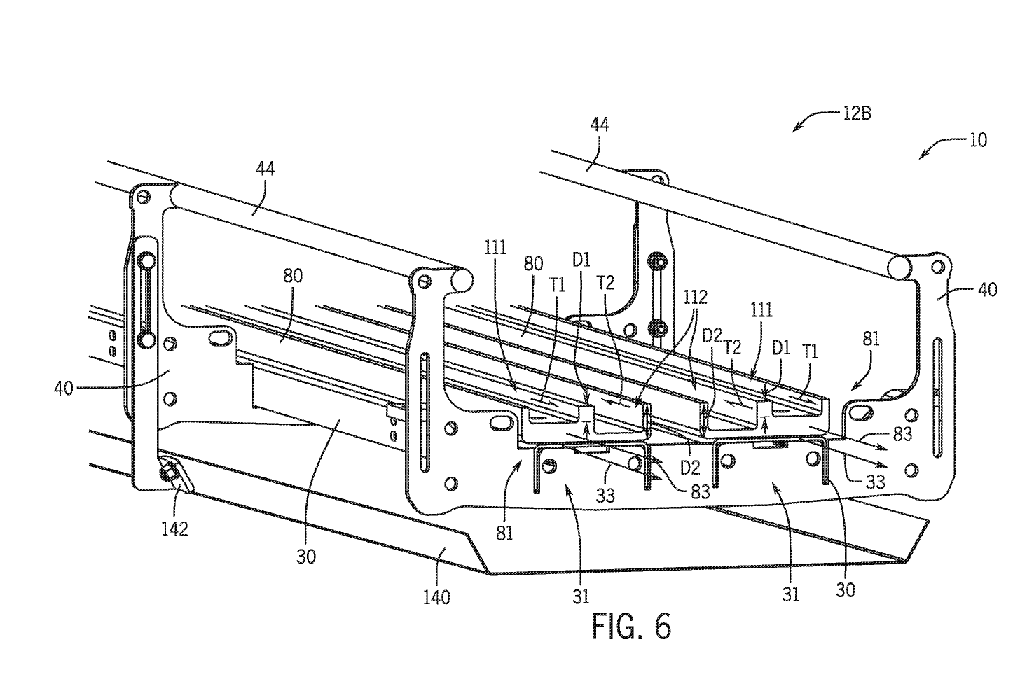

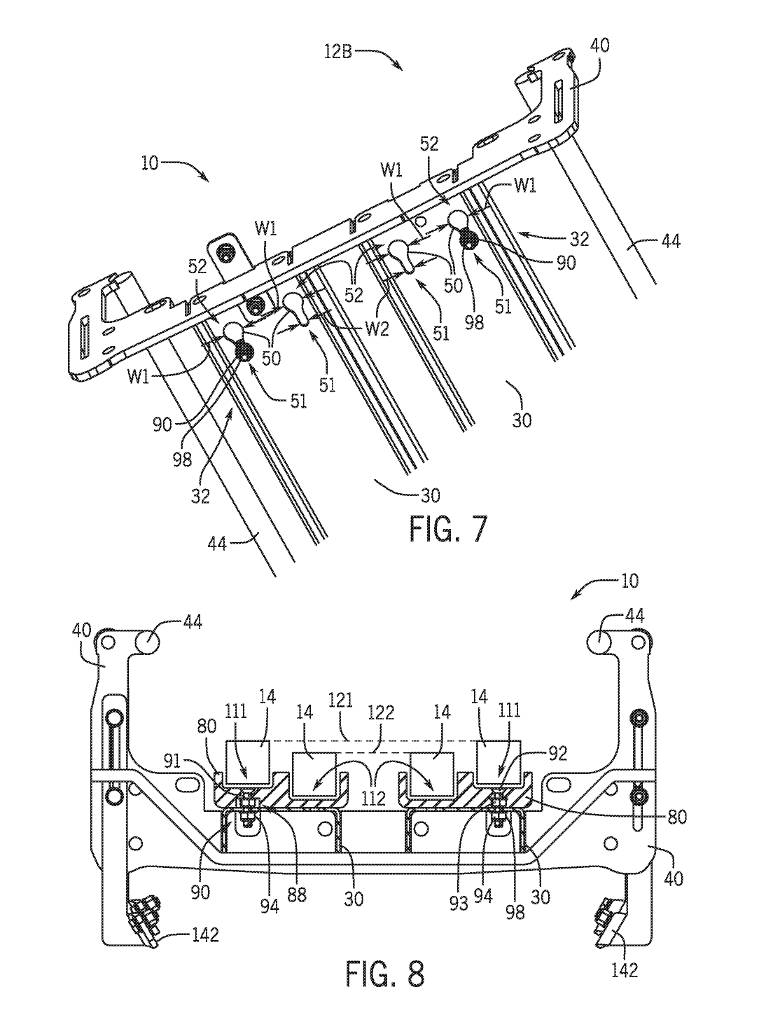

Each slot 50 has an enlarged end 52 and an opposite narrow end 54 (FIGS. 7 & 9). The width of the enlarged end 52 (see width W1 on FIG. 7) is larger than the width of the narrow end 54 (see width W2 on FIG. 7). The enlarged ends 52 are also oriented toward the second frame end 32 (see FIG. 9) to thereby prevent inadvertent movement of the liner 70 toward the first frame end 31 as the chain 14 (FIG. 3) is driven along the chain conveyor 10. Each slot 50 extends between the ends 52, 54 and has a length L (FIG. 9). The length, size, and shape of the shape of the slots 50 can vary. The liner 70 can be made of any suitable material, such as extruded plastic.

In the example shown in FIG. 9, the length of slots 50 incrementally decreases as the slots 50 are positioned away from the first frame end 31. That is, a first slot 50A positioned next to the first frame end 31 has a first length L1, a second slot 50B has a second length L2 that is less than the first length L1, a third slot 50C has a third length L3 that is less than the second length L2, and so on (e.g. fourth slot 50D with fourth length L4, fifth slot 50E with fifth length L5). In the example depicted, the first slot 50A is positioned near the first frame end 31 and the fifth slot 50E is positioned near the second frame end 32. The present inventor has discovered that the differing lengths of the slots advantageously prevents all of the fasteners 90 (described herein) from inadvertently moving in slots 50A-E if the frame member 30 is installed incorrectly (e.g. reversed, flipped).

The frame members 30 are coupled to and supported by one or more support brackets 40. The support brackets 40 are configured to support the frame members 30 from the ground, the ceiling, or a support structure. In the example depicted, the support brackets 40 are coupled to and supported from an overhead support structure (not shown) such that the frame members 30 are vertically supported above the factory floor. Stiffening members 44 are connected to the support brackets 40 and extend between adjacent support brackets 40 to thereby increase the stiffness and rigidity of the conveyor section 12B.

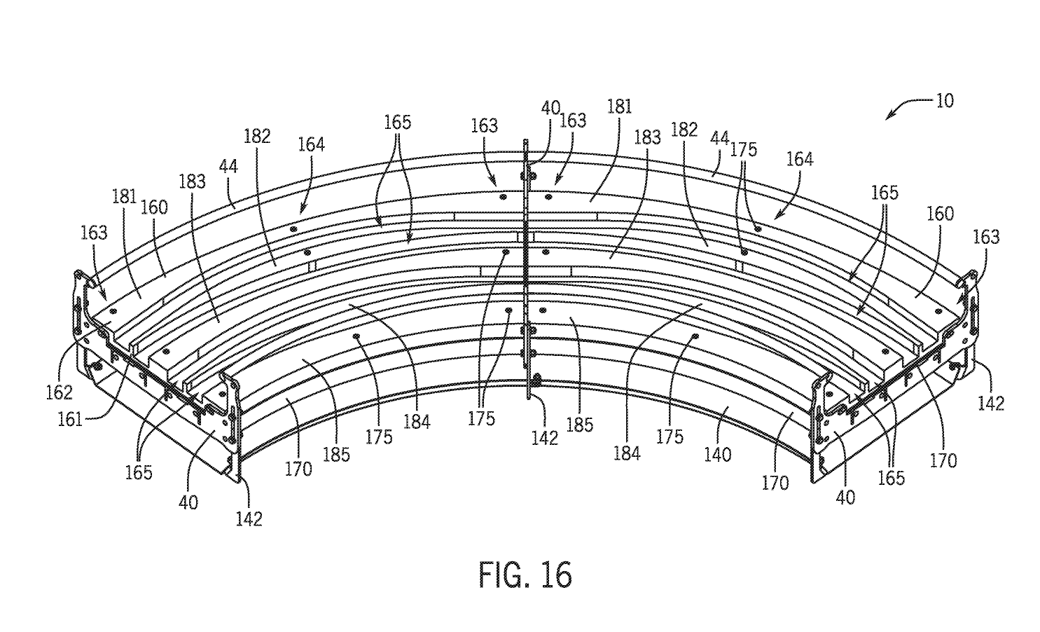

The conveyor section 12B also includes a drip tray or pan 140 (best shown in FIGS. 4 & 6) positioned vertically below the frame member 30 and a liner 80 (described herein) to catch any debris or fluids that may fall from the frame member 30 or liner 80. The shape of the drip pan 140 corresponds to the shape of the conveyor section 12B (see also the drip pan 140 included with conveyor section 12A shown in FIG. 3 and the drip pan 140 included with conveyor section 12C shown in FIG. 16). The width of the drip pan 140 is larger than the overall width of the conveyor section 12A, 12B, 12C. The drip pan 140 is coupled to the support brackets 40, and the support brackets 40 are adjustable so as to permit vertical adjustment of the drip pan 140 relative the frame member 30 such that the drip pan 140 can be sloped toward one frame end 31, 32 of the frame member 30. When the drip pan 140 is sloped toward one frame end 31, 32 of the frame member 30, debris or fluids are directed or flow to a drain or collection reservoir (not shown). The drip pan 140 includes one or more pan brackets 142 (FIG. 6) that connect to the support brackets 40.

Liners 80 are installed onto to the frame members 30 to support the chains 14 (see FIGS. 3 and 8) relative to the frame members 30 as the chains 14. The liners 80 are removably coupled to the frame members 30 with fasteners 90 (see FIG. 5; the fasteners 90 are described further herein) such that the liners 80 can be easily removed by operators for maintenance and cleaning. FIG. 4 depicts the liners 80 installed onto the frame members 30, and FIG. 5 depicts the liners 80 disconnected from the frame members 30.

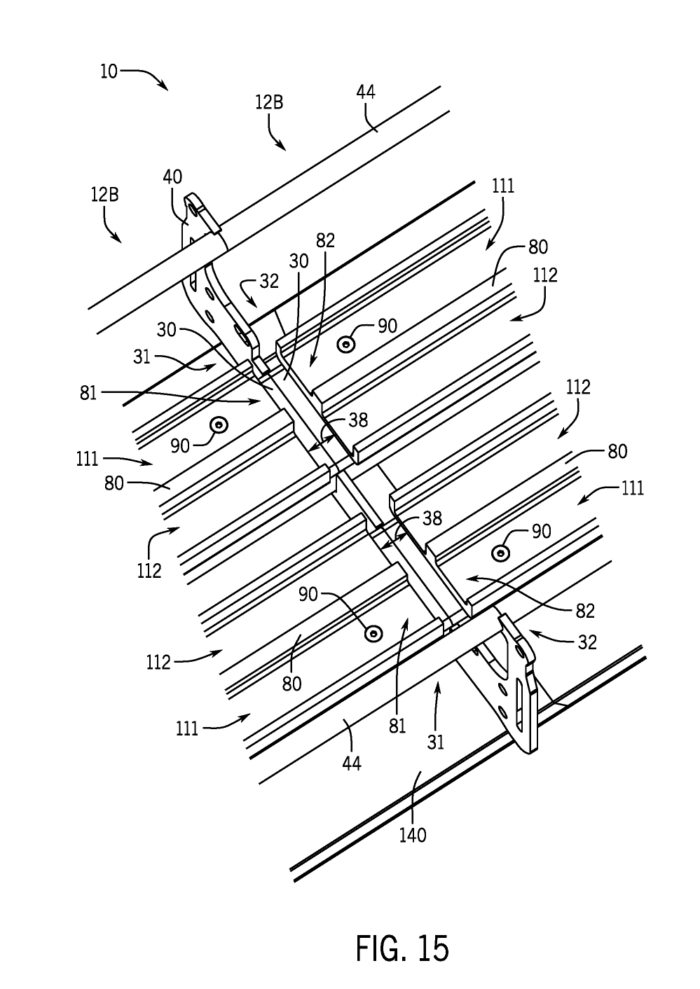

Now referring to FIG. 6, liners 80 are shown installed on the frame members 30. Each liner 80 has a liner axis 83 along which the liner 80 extends between the ends of the liner 80, namely a first liner end 81 and an opposite second liner end 82 (FIG. 5). The liner axis 83 is parallel to the frame axis 33, and the liner axis 83 is shown offset from the center of the liner 80. The length of the liner 80 (liner length 86 shown on FIG. 11) is less than the length of the frame member 30 (frame length 36 shown on FIG. 11) such that the liner 80 can be axially moved along the frame member 30 without interfering with another liner 80 on an adjacent conveyor section 12B (see also FIG. 15). The liner ends 81, 82 are also spaced apart from the support brackets 40 that are coupled to the frame ends 31, 32 of the frame members 30 (see FIGS. 9 & 15)

Referring to FIGS. 6 and 8, each liner 80 includes a pair of channels, namely a first channel 111 and a second channel 112, which are adjacent and parallel to each other. The channels 111, 112 extend along the length of the liner 80 and support the chain 14 relative to the conveyor section 12B and the frame members 30. The depth of the first channel 111 (depth D1 shown on FIG. 6) is less than the depth (depth D2 on FIG. 6) of the second channel 112.

In the instance that the chain 14 conveyed by the chain conveyor 10 is a continuous chains, each continuous chain 14 is driven in a continuous loop first through the first channel 111 of one of the liners 80 in a first direction T1 (e.g. direction of travel of the products) (see arrow T1 on FIG. 6) and then through the second channel 112 of the same liner 80 in a second direction T2 (e.g. opposite the direction of travel of the products) (see arrow T2 on FIG. 6). The tops of the chains 14 in the first channels 111 are positioned at a first plane 121 (FIG. 8) and the tops of the chains 14 in the second channels 112 are at a second plane 122 that is vertically below the first plane 121. As such, the chains 14 that are conveyed in the second channels 112 pass under the product (not shown) without contacting or affecting the direction of the travel of the products.

Each liner 80 is installed and coupled the frame members 30 with one or more fasteners 90 (best shown on FIGS. 5, 8 and 14). The fasteners 90 extend from the liner 80 and extend toward the frame member 30. The fasteners 90 are spaced apart from each other along the liner 80. Each fastener 90 has an enlarged head 98 (FIGS. 8 and 14) that is moved through the enlarged end 52 (see FIG. 7) of one of the slots 50 when the liner 80 is installed onto the frame member 30. The fasteners 90 are also spaced apart along the liner axis 83 (see FIG. 9). Any suitable type of fastener 90 can be used to install the liner 80 onto the frame member 30. The size, shape, and type of fasteners 90 can vary, and the fasteners 90 can be integrally formed with or into the liners 80. The fasteners 90 are positioned below the first channel 111 such that the fasteners 90 do not extend into the first channel 111.

In the example depicted (referring specifically to FIGS. 8 & 14), the fastener 90 is removably coupled to the liner 80 and has a threaded bolt 91 with a bolt head 92 that is recessed into a cutout 88 defined in the liner 70, a locking nut 93, and an installation nut 94. The locking nut 93 is used to lock the bolt 91 onto the liner 80 such that the liner 80 is sandwiched between the bolt head 92 and the locking nut 93. The installation nut 94 is used to install the liner 80 onto the frame member 30. When the liner 80 is installed onto the frame member 30, the installation nut 94 is moved toward the locking nut 93 to thereby sandwich the frame member 30 between the liner 80 and the locking nut 93. The movement of the installation nut 94 toward the locking nut 93 tightens the liner 80 into contact with the frame member 30. In this example fastener, the installation nut 94 is the enlarged head 98 of the fastener 90 and can move axially along the bolt 91. The width of the installation nut 94 closely matches the width the enlarged end 52 (W1 on FIG. 7) of the slot 50, and the width of the bolt 91 closely matches the width of the narrow end 54 (W2 on FIG. 7) of the slot 50.

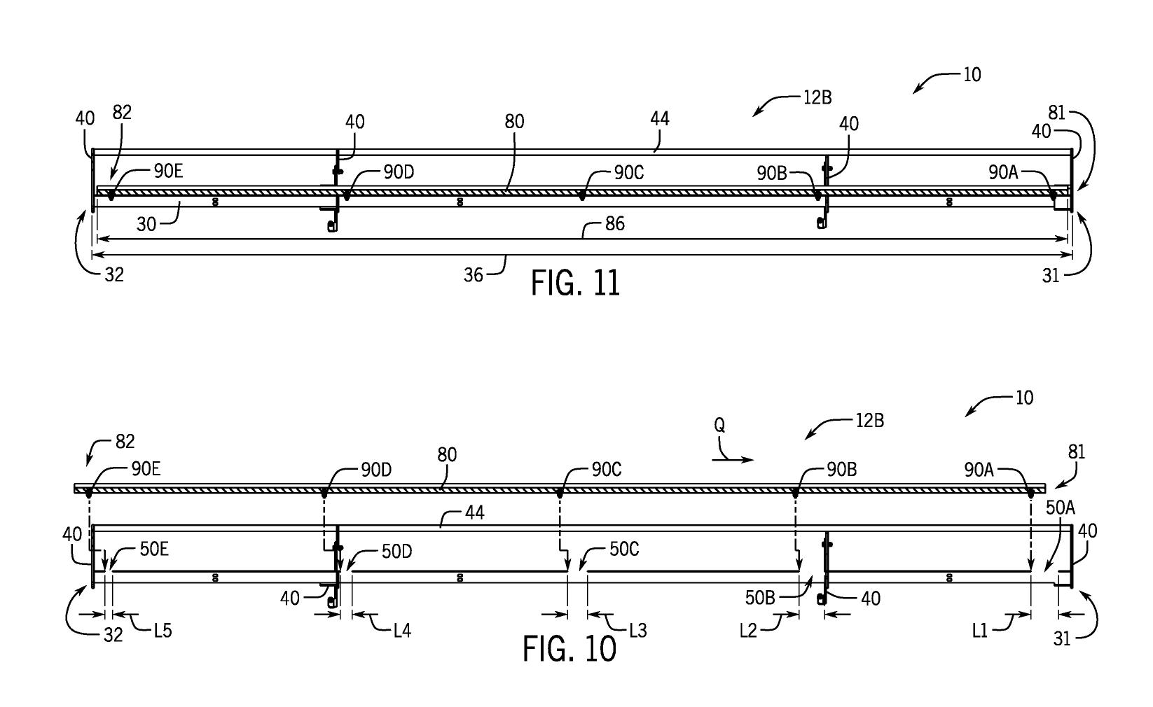

An example installation sequence for installing the liner 80 onto the frame member 30 is described herein below with reference to FIG. 10. The liner 80 in FIG. 10 is depicted spaced apart from the frame member 30 for clarity; however, the liner 80 may be immediately adjacent to the frame member 30 during installation. The liner 80 is installed onto the frame member 30 by aligning and transversely moving a first fastener 90A into the first slot 50A and then axially moving (e.g. sliding) (see direction arrow Q) the liner 80 along the frame member 30 toward the first frame end 31 until the second fastener 90B is aligned with the second slot 50B and can be transversely moved into the second slot 50B. The liner 80 is then further axially slid along the frame member 30 toward the first frame end 31 (direction arrow Q) until the third fastener 90C is aligned with the third slot 50C and can be transversely moved into the third slot 50C. As the liner 80 is axially slid along the frame member 30, the fasteners 90A, 90B that have been moved into the corresponding slots 50A, 50B move axially in the slots 50A, 50B. The liner 80 is then further axially slid along the frame member 30, as described above, until all subsequent fasteners 90C, 90D, 90E are aligned with and moved into the corresponding slots 50C, 50D, 50E. FIG. 11 depicts the liner 80 installed onto the frame member 30 (FIG. 11). It is noted that the fasteners in the slots are moved in the slots as the liner is slid along the frame member until all the fasteners are moved into the slots and installation is complete.

Once the fasteners 90A-E are received into the slots 50A-E (as shown in FIG. 11), the enlarged heads 98 (FIG. 8) of the fasteners 90A-E are moved into contact with the frame member 30 to thereby secure the liner 80 to the frame member 30. The enlarged heads 98 of the fasteners 90A-E are also configured to prevent the liner 80 from being moved inadvertently out of the slots 50A-E when the liner 80 is installed onto the frame member 30. That is, the enlarged heads 98 of the fasteners 90A-E only pass through the slot 50A-E when the enlarged heads 98 are at the enlarged ends 52 of the slots 50A-E (e.g. the enlarged heads 98 of the fasteners 90A-E do not pass through the narrow ends 54 of the slots 50A-E).

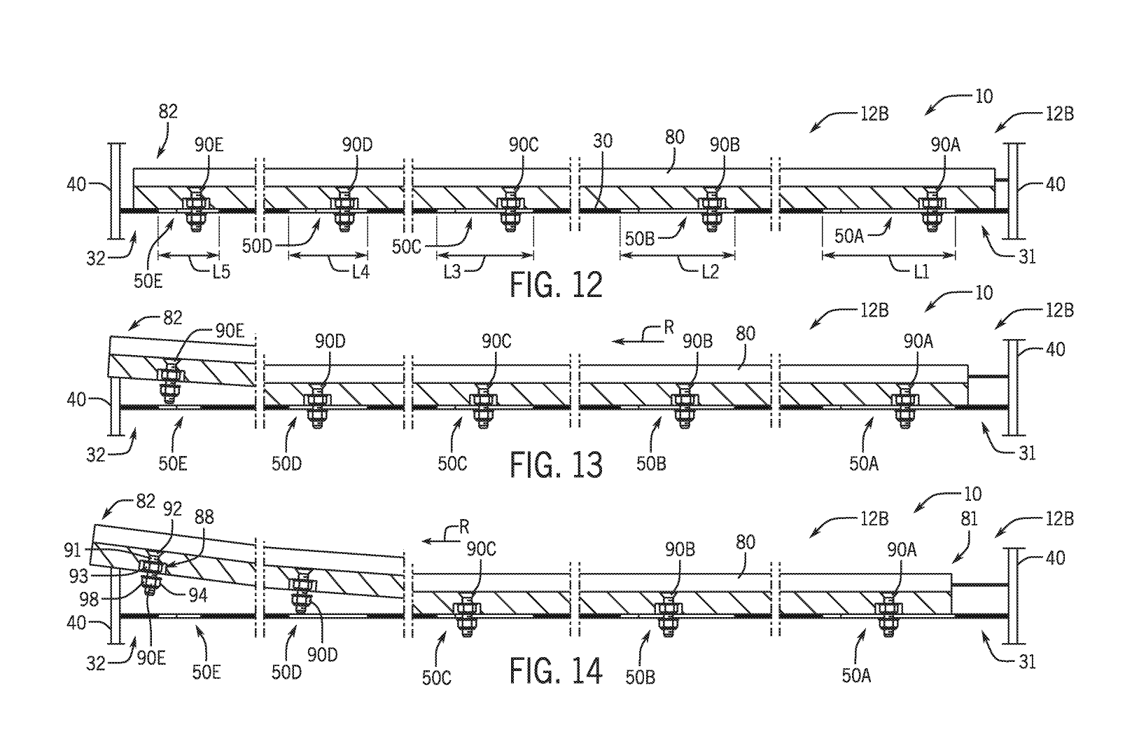

Referring now to FIGS. 12-14, example removal sequence for removing the liner 80 from the frame member 30 is depicted. FIG. 12 depicts the liner 80 installed onto the frame member 30. FIG. 13 depicts the liner 80 being axially slid along the frame member 30 (in direction R) such that the fasteners 90A-E move in the slots 50A-E and the fastener 90E nearest the second frame end 32 is moved out of the slot 50E. FIG. 14 depicts the liner 80 being further axially slid along the frame member 30 such that the fasteners 90A-D move in the slots 50A-D and fastener 90D is moved out of the slot 50D. This sequence continues until all remaining fasteners 90A-C are moved out of the slots 50A-C.

FIG. 15 depicts two conveyor sections 12B coupled to each other at a single support bracket 40. The frame members 30 from each conveyor section 12B rest on and are coupled to the suspension bracket 40. A gap 38 is defined between the frame members 30 liners 80 of the adjacent conveyor sections 12B such that the liners 70 can be moved without obstructing or contacting the each other.

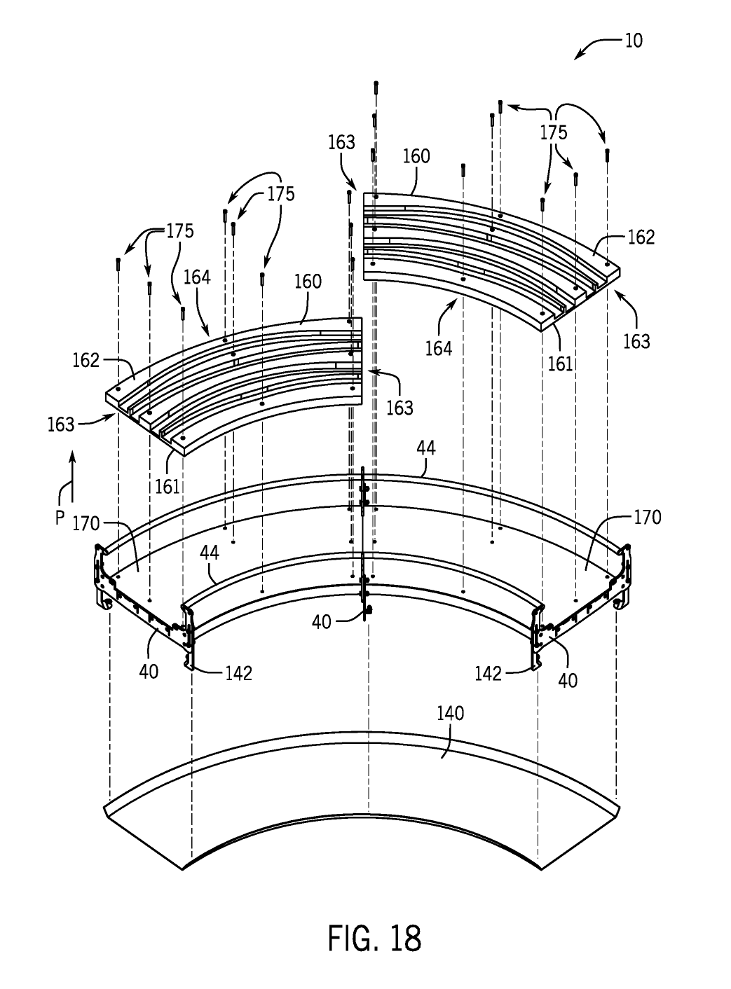

Referring now to FIGS. 16-18, another example conveyor section 12C of the present disclosure is shown. This conveyor section 12C is a curved conveyor section with liners 160 that are installed onto a frame member 170. Each liner 160 has a lower surface 161 and an opposite the upper surface 162. The liners 160 defines four channels 165 through which the chains 14 (FIG. 3) are conveyed. The liners 160 are removably coupled or fastened to the frame members 170 with fasteners 175, such as screws and bolts. To remove or decouple the liners 160 from the frame members 170, the fasteners 175 are removed and the liners 160 are moved away from the frame members 170 (see arrow P on FIG. 18). The liners 160 can then be cleaned and re-coupled to the frame member 170 with the fasteners 175.

Each liner 170 has five walls 181-185 that define the channels 165 through which the chains 14 (FIG. 1) are conveyed. Through research and experimentation, the present inventor has determined that the shape of the walls 181-185, such as the height and width, can be varied along the length of the walls 181-185 to thereby strengthen the walls 181-185. In particular, the walls 181-185 are thickened (width increased) at locations along the length of the walls 181-185 that experience increased compression forces applied by the chains 14 to the walls 181-185 as the chains 14 are conveyed through the channels 165 of the curved conveyor section 12C. By forming the liners 160 with walls 181-185 having increased widths at specific locations along the length of the walls 181-185, the strength and rigidity of the channels 165 is increased.

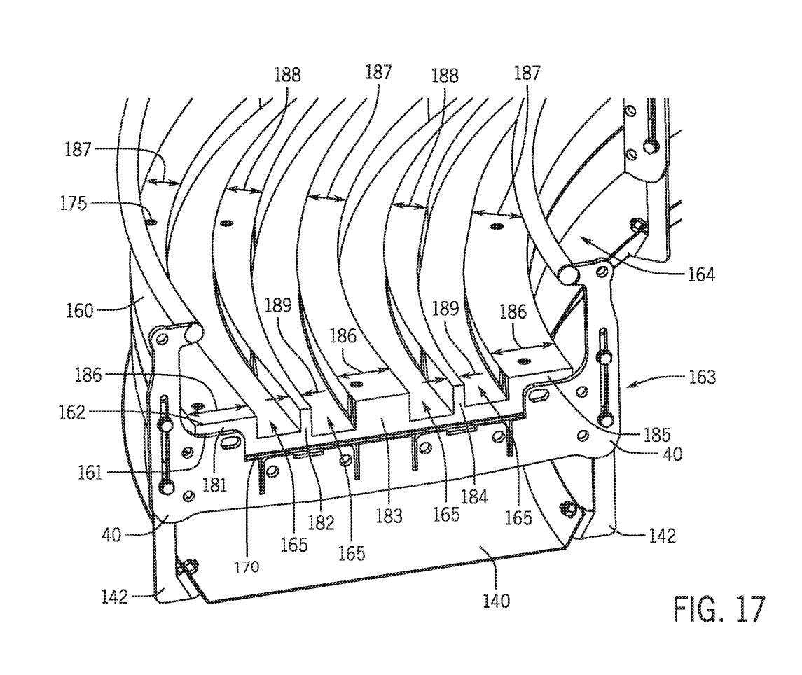

Referring specifically to FIG. 17, three walls 181, 183, 185 have enlarged widths 186 at the ends 163 of the liner 160 and narrow widths 187 at the middle 164 of the liner 160 relative to the enlarged widths 186. Also, two walls 182, 184 have enlarged widths 188 at the middle 164 of the liner 160 and narrow widths 189 at the ends 163 of the liner 160 relative to the enlarged widths 188. The walls 181-185 are also designed to prevent the chains 14 from moving vertically out of the liner 160 and/or toward the center of the curve/radius of the liner 160. The present inventor has recognized that by optimizing the shape of the walls 181-185, the liners 160 of the present disclosure do not require any additional reinforcing members that are commonly used in conventional conveyor sections to resist the compression forces applied by the chains 14 as the chains 14 move around curves.

In the present description, certain terms have been used for brevity, clarity, and understanding. No unnecessary limitations are to be inferred therefrom beyond the requirement of the prior art because such terms are used for descriptive purposes only and are intended to be broadly construed. The different apparatuses, systems, and methods described herein may be used alone or in combination with other apparatuses, systems, and methods. Various equivalents, alternatives and modifications are possible within the scope of the appended claims.

What is claimed is:

1. A conveyor for supporting a chain, the conveyor comprising:
a frame member having a first slot and a second slot spaced apart from each other along the frame member;
a liner configured to support the chain relative to the frame member; and
a first fastener and a second fastener spaced apart from each other and extending from the liner toward the frame member;
wherein the liner is installed onto the frame member by moving the first fastener into the first slot and sliding the liner along the frame member until the second fastener is aligned with the second slot and can be moved into the second slot.

2. The conveyor according to claim 1, wherein the frame member has a frame axis along which the frame member extends and along which the first slot and the second slot are aligned;
wherein the liner has a liner axis along which the liner extends and along which the first fastener and the second fastener are aligned; and
wherein the liner axis is parallel to the frame axis.

3. The conveyor according to claim 2, further comprising a third fastener along the liner axis, spaced apart from the first fastener and the second fastener, and extending from the liner toward the frame member;
wherein the frame member has a third slot along the frame axis and spaced apart from the first slot and the second slot; and
wherein the liner is further slid along the frame member until the third fastener is aligned with the third slot and can be moved into the third slot.

4. The conveyor according to claim 3, wherein the first fastener is moved in the first slot and the second fastener is moved in the second slot as the liner is slid along the frame member until the third fastener is aligned with the third slot.

5. The conveyor according to claim 3, wherein the second slot is positioned between the first slot and the third slot;
wherein each of the first slot, the second slot, and the third slot has a length;
wherein the length of the first slot is greater than the length of the second slot; and
wherein the length of the second slot is greater than the length of the third slot.

6. The conveyor according to claim 4, wherein each of the first slot, the second slot, and the third slot has an enlarged end;
wherein each of the first fastener, the second fastener, and the third fastener has an enlarged head; and
wherein as the liner is installed onto the frame member the enlarged head of the first fastener is moved through the enlarged end of the first slot, the enlarged head of the second fastener is moved through the enlarged end of the second slot, and the enlarged head of the third fastener is moved through the enlarged end of the third slot.

7. The conveyor according to claim 6, wherein once the liner is installed onto the frame member the enlarged head of the first fastener, the enlarged head of the second fastener, and the enlarged head of the third fastener prevents the liner from being moved away from the frame member.

8. The conveyor according to claim 7, wherein the enlarged head of the first fastener, the enlarged head of the second fastener, and the enlarged head of the third fastener are moved into contact with the frame member to thereby secure the liner to the frame member and prevent axially sliding of the liner relative to the frame member.

9. The conveyor according to claim 6, wherein the liner comprises a first channel and a second channel adjacent to the first channel;
wherein the first channel is configured to vertically support the chain above the frame member along a first plane as the chain is conveyed in a first direction; and
wherein the second channel is configured to vertically support the chain above the frame member along a second plane that is vertically below the first plane as the chain is conveyed in a second direction that is opposite the first direction.

10. The conveyor according to claim 9, wherein the first fastener, the second fastener, and the third fastener are positioned vertically below the first channel.

11. The conveyor according to claim 6, wherein the frame member has a first end and an opposite second end, and wherein the enlarged end of the first slot, the enlarged end of the second slot, and the enlarged end of the third slot are each oriented toward the second end of the frame member.

12. The conveyor according to claim 11, further comprising a first support bracket coupled to the first end of the frame member and a second support bracket coupled to the second end of the frame member, and wherein the first support bracket and the second support bracket are configured to vertically support the frame member and the liner.

13. The conveyor according to claim 12, further comprising a drip pan coupled to the first support bracket and the second support bracket such that the drip pan is vertically directly below the frame member and the liner.

14. The conveyor according to claim 13, wherein the first support bracket and the second support bracket permit vertical adjustment of the drip pan relative to the frame member such that the drip pan can be sloped toward the first end of the frame member or the second end of the frame member.

15. The conveyor according claim 12, wherein the liner has a first end and an opposite second end, and wherein the frame member has a frame length and the liner has a liner length that is less than the frame length such that the first end of the liner is spaced apart from the first support bracket and the second end of the liner is spaced apart from the second support bracket.

16. The conveyor according to claim 12, further comprising a stiffening member that is coupled to and extends between the first support bracket and the second support bracket to thereby increase rigidity of the conveyor.

17. A method for assembling a conveyor that conveys and supports a chain, the method comprising:
positioning a first slot and a second slot along a frame member such that the first slot is spaced apart from the second slot;
positioning a first fastener and a second fastener along a liner such that the first fastener and the second fastener extend from the liner toward the frame member, the first fastener being spaced apart from the second fastener; and
installing the liner onto the frame member by moving the first fastener into the first slot and sliding the liner along the frame member until the second fastener is aligned with the second slot and can be moved into the second slot.

18. The method according to claim 17, further comprising:
positioning a third slot along the frame member such that the third slot is spaced apart from the first slot and the second slot;
positioning a third fastener along a liner such that the third fastener extends from the liner toward the frame member, the third fastener being spaced apart from the first fastener and the second fastener; and
sliding the liner along the frame member until the third fastener is aligned with the third slot and can be moved into the third slot.

19. The method according to claim 18, wherein the first fastener is moved in the first slot and the second fastener is moved in the second slot as the liner is slid along the frame until the third fastener is aligned with the third slot.

20. The method according to claim 19, wherein the first fastener, the second fastener, and the third fastener each have an enlarged head, and further comprising moving the enlarged head of the first fastener, the enlarged head of the second fastener, and the enlarged head of the third fastener into contact with the frame member to thereby secure the liner to the frame member and prevent sliding of the liner relative to the frame member.
